(19) United States
(12) Patent Application Publication
(10) Pub. No.: US 2009/0049074 A1
(43) Pub. Date: Feb. 19, 2009

(54) CONTENT MANAGEMENT SYSTEM

(75) Inventors: Joseph Dara-Abrams, Los Altos, CA (US); Simon Gibbs, San Jose, CA (US)

Correspondence Address: FITCH EVEN TABIN & FLANNERY, 120 SOUTH LASALLE SUITE 1600, CHICAGO, IL, 60603, US

(73) Assignees: SONY CORPORATION, A JAPANESE CORPORATION, Tokyo (JP); SONY ELECTRONICS INC., A DELAWARE CORPORATION, Park Ridge, NJ (US)

(21) Appl. No.: 11/839,523

(22) Filed: Aug. 15, 2007

(51) Int. Cl. G06F 17/30

(52) U.S. Cl. 707/102; 707/E17.005

(57) ABSTRACT

A content management server is provided. The content management server includes at least one relay element to identify media content and media players within a network and acquire content characteristic information from the media content and media player characteristic information from the media players. A database stores the content characteristic information and the media player characteristic information. A processor performs a compatibility test, based on the content characteristic information and the media player characteristic information, to determine whether selected media content is playable on any of the media players and to indicate a result of the compatibility test via a user interface.

### FIELD OF THE APPLICATION

The present invention relates generally to a content management system for a home network.

### BACKGROUND

Consumers can now purchase digital content from online services and download the content to devices such as personal computers, media servers, and portable players. Currently, commercial content exists in a variety of formats having different coder-decoders (“codecs”) and file formats. The commercial content is often managed by a variety of digital rights management (“DRM”) systems, and may be licensed from a variety of services. It is possible that in a household, the same “content entity” (e.g., a particular audio file, video, or other media) may be stored on multiple devices, or may be stored in multiple copies on the same device, each with potentially different formats, DRM, and licensing constraints. Furthermore, the capabilities of media players differ in terms of their support for file formats, codecs, DRM, and network protocols. As a result, in some situations it is very difficult for a consumer to determine whether a “content entity” is playable on a particular device or not, and, if not, the reason for the failure. This can result in problems for a consumer. For example, if the consumer purchases and downloads a particular media file such as a digital audio file, the consumer might not know whether the digital audio file is playable until after it has already been downloaded. The consumer might have two computers, one portable music player, and several audio programs or services capable of playing digital audio files. If the digital audio file is downloaded onto one of the computers, the consumer can try to play the song with the default media player. In the event that the default media player on the computer cannot play the song, the consumer would have to take the trouble to manually select other media players in an attempt to play the digital audio file.

If none of the media players on the computer can play the song, the user can try to play the song on the portable music player or on the other computer. However, the consumer typically has to store the song on a portable memory device and then upload the song onto the portable memory device or the other computer from the portable memory device. This entire process can be cumbersome and wasteful in terms of time spent. Moreover, in the event that none of the consumer's media players can play the file, the user may feel as though the money was wasted purchasing the digital audio file.

Current entertainment systems sometimes play or store media content files that have associated metadata. For example, the metadata for an audio song file sometimes includes information about the artist and the name of a song. In current systems, the metadata for an audio song file may be scattered through different electronic devices. For example, there could be one version of the song stored in the Windows Media Video (“WMV”) format that has metadata, and another copy of the song stored in Moving Picture Experts Group (“MPEG”)-1 Audio Layer 3 (“MP3”) format that has different metadata associated with it. In the event that the user plays one of these song files, current systems would only provide the metadata associated with the particular song file to the user, even though the metadata from the other song file or from some other media source might be highly relevant.

### SUMMARY

At least one embodiment of the invention is directed to a method. A network is crawled (that is, its state is methodically and comprehensively examined) to identify media content and media players within the network. Content characteristic information is acquired from the media content and media player characteristic information from the media players. The content characteristic information and the media player characteristic information are stored in a database. A compatibility test is performed, based on the content characteristic information and the media player characteristic information, to determine whether selected media content can be played on any of the media players. The result of the compatibility test is subsequently indicated to a user.

At least one embodiment of the invention is directed to a content management server. The content management server includes at least one relay element to identify media content and media players within a network and acquire content characteristic information from the media content and media player characteristic information from the media players. A database stores the content characteristic information and the media player characteristic information. A processor performs a compatibility test, based on the content characteristic information and the media player characteristic information, to determine whether selected media content is playable on any of the media players and to indicate a result of the compatibility test via a user interface.

At least one embodiment of the invention is directed to a network. The network includes at least one electronic device to implement at least one media player, at least one content source to store media content, and a content management server. The content management server is adapted to (a) crawl the network to identify the media content and the at least one media player within the network; (b) acquire content characteristic information from the media content and media player characteristic information from the at least one media player; (c) store the content characteristic information and the media player characteristic information in a database; (d) perform a compatibility test, based on the content characteristic information and the media player characteristic information, to determine whether selected media content can be played on any of the at least one media player; and (e) indicate a result of the compatibility test to a user.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates a content management system according to an embodiment of the invention;

FIG. 2 illustrates the content management server according to an embodiment of the invention;

FIG. 3 illustrates a content source according to an embodiment of the invention;

FIG. 4 illustrates a system where a content management server is utilized to determine whether media content W stored on source X is playable on a media player stored on device Y according to an embodiment of the invention;

FIG. 5 illustrates a method implementing a compatibility test to determine whether media content W stored on the source X is playable on the media player of device Y according to an embodiment of the invention;

FIG. 6 illustrates a display screen presented to the user according to an embodiment of the invention; and

FIG. 7 illustrates a method of implementing the content management system according to an embodiment of the invention

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Embodiments of the present invention are directed to a content management system for a local network, such as a home network. Several electronic storage devices for storing digital media are connected to the local network. Several other electronic devices may also be in communication with the local network. Each of the electronic devices may include a media player for playing the digital media for a user's enjoyment. It should be appreciated that some, or all, of the electronic devices may include one or more media players and a memory for storing one or more items of the digital media.

A content management server is in communication with the local network and manages the available media content and electronic devices for the user. The content management server includes a database and determines the electronic devices and digital media available on the local network. The content management server crawls the local network to determine which electronic devices are on the local network and which digital media are available. The content management server also determines which media players and/or services are available on the local network. The local network may be set up according to Digital Living Network Alliance (“DLNA”) guidelines or protocols such that the content management server can detect whenever a new electronic device is connected to the local network. In some embodiments the content management server may also periodically query the various electronic devices on the local network to determine whether any new media or changes have been made since the last time the content management server queried the local network.

The content management server may store various information retrieved during its periodic crawls in a lookup table stored in the database. The content management server acquires metadata from the various entities queried during its crawls. The metadata is utilized to identify or characterize media content, media players, or media servers with which it is associated. Metadata for media content such as an audio song file may identify, for example, the artist of the song, the DRM for the song, the year during which the song was originally recorded, the year during which the particular song file was created, the style of singing in the song (e.g., Pop or Rock 'n Roll) as well as other relevant information that can be used to identify or characterize the song. Metadata for a media player may include, for example, information regarding the supported media content types that can be played by the media player, and any other relevant information. Metadata for a media service, such as iTunes™ may include, for example, information regarding DRM and any other relevant information.

A list of all of the media players located during one of the content management server's crawls may be stored in the database. The database may be stored within the server in some embodiments and external to the content management server in other embodiments. The database may include the supported file types playable on each of these media players, such as Audio Video Interleave (“AVI”), Moving Picture Experts Group (“MPEG”)-1 Audio Layer 3 (“MP3”), or MPEG-4 Part 14 (“MP4”). It should be appreciated that many additional file types may also be playable, and these three examples are listed here for the sake of brevity. The lookup table may also store a list of codecs supported by each of these media players. The database may further contain DRM information for the various media content stored on the database.

The database may also be utilized to store information indicating which devices holds licenses, what licensing constraints may apply, and which subscriptions or accounts have been created. Replication data may also be stored in the database. The replication data may indicate whether a particular media content file is unique within the local network or whether it is a copy of another media content file.

Media player metadata may also be stored in the database. The media player metadata may include support for file formats, codecs, DRMs, network protocols, license operations (such as importing a license), media player location, manufacturer and device type, as well as the current status of the media player. Finally, the database may include information to indicate the capabilities of a content source such as, for example, support for various network protocols, and license operations, such as exporting a license.

The information stored within the database may be utilized to perform compatibility tests. For example, a compatibility test may be performed to determine whether a media content file stored on a particular source device can be played with a media player on a particular electronic device. For example, it would be helpful for a user to know whether a media content file currently stored on a home computer will be playable on a portable media device such as an iPod™ or MP3 media player.

The compatibility test may also be performed to indicate whether a particular media content file can be played on any device on the local network. This may be relevant in a situation where a user desires to purchase the media content file. It may be useful if the user can determine whether a media content file is playable before paying for it and downloading it.

As discussed above, the content management server acquires metadata from various entities when crawling the local network. The content management server also acquires additional metadata from external sources that is associated with, for example, media content detected on the local network. In the event that a particular song file has been detected on the local network, the content management server may query an external database to acquire additional relevant metadata for the song file, such as an image of an associated album cover or user reviews of the song and/or the album from which the song was originally released. This metadata may be presented to the user in a number of ways. For example, when the song file is played, the image of the album cover may be displayed on a monitor or television screen, along with one or more of the user reviews.

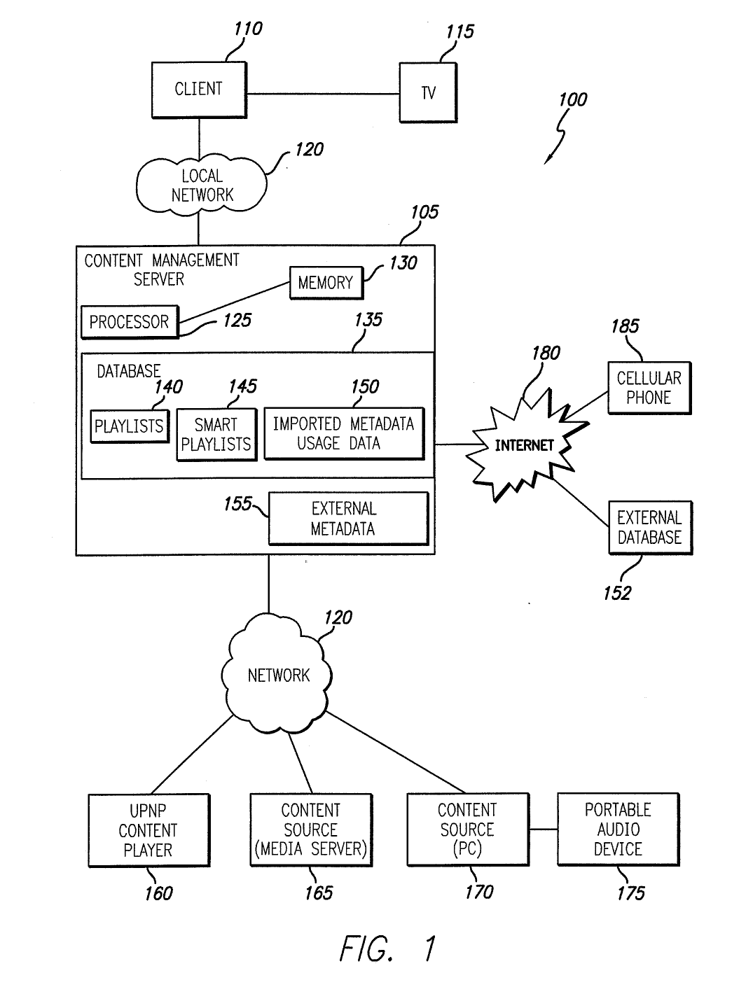

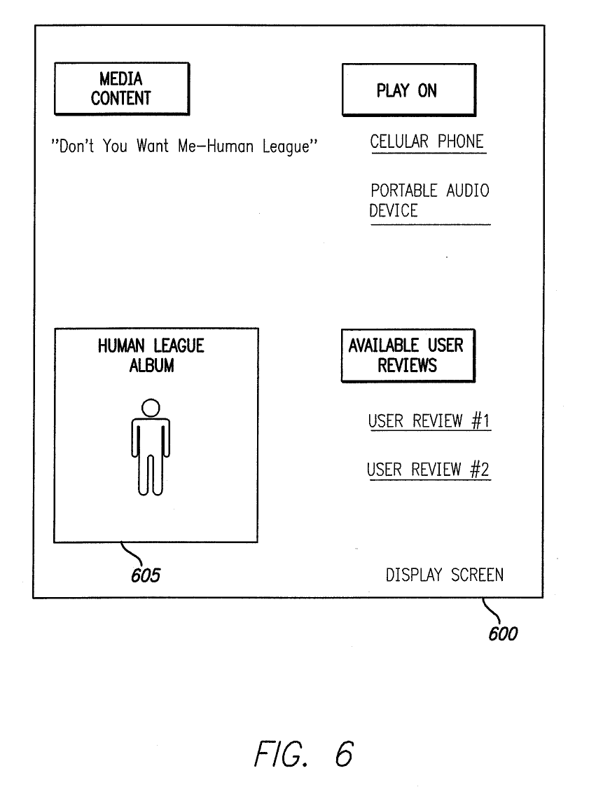

FIG. 1 illustrates a content management system 100 according to an embodiment of the invention. The content management system 100 includes a content management server 105 that stores information about the various media content. The media sources may include various electronic devices with memories that are in communication with the content management server 105 via a local network 120. Although only a local network 120 is shown, a person of ordinary skill in the art would readily appreciate that the teachings described herein are equally applicable to non-local networks, such as wide area networks. The memories may be stored in computers, servers, or other storage devices accessible by the local network 120. A client 110 is in communication with the content management server 105. The client 110 may implement a user interface to display media content-related information to a user. The user interface may be displayed on a television (“TV”) 115 or another type of electronic monitor. The user interface may display various media files available via the local network 120 and may also display media players and media sources available via the local network 120, as discussed below with respect to FIG. 6. The user interface may further display available playlists and cover images corresponding to the media content available on the local network 120. For example, the cover images may include images of an album from which a particular song file was created.

FIG. 1 illustrates the client 110 as being separate from the content management server 105. However, a person of skill in the art would readily appreciate that in other embodiments the client 110 may be stored within or implemented by the content management server 105. The client 110 may be a software module implemented by a processor within the content management server 105 or, for example, a processor within the TV 115.

The content management server 105 includes a variety of elements, such as a processor 125 and a memory 130. The processor 125 may implement program code or instructions stored on the memory 130. The content management server 105 also includes a database 135. The database 135 stores the various information acquired when crawling the local network 120. For example, the database 135 may include playlists 140. The playlists 140 may be created by a user and may include the identities of various song files. For example, a particular playlist 140 may include the identities of certain favorite song files. The database 135 may also include smart playlists 145. A smart playlist 145 is a list of songs, and membership is the list is determined by a predicate such as “all songs by U2” or “all songs of where the genre is R&B and played in the last two weeks.” The database 135 also includes imported metadata usage data 150. The imported metadata usage data 150 may include metadata acquired from the various entities on the local network 120. For example, metadata from various song files may include the name of the singer and/or a band name, as well as a music category such as Rock 'n Roll or Oldies, and may also include information indicating whether the song file is an original file or whether it is a copy of an original song file. The metadata may further include images associated with the song file, such as an image of an album cover from which the song file was generated. Additional metadata may include content identifiers such as a serial number for the sound file or a signature extracted from a waveform of the sound in the song file. For example, the waveform may include a unique pattern of frequencies that can be utilized to uniquely identify the song file.

The imported metadata usage data 150 may also include metadata for media players. The metadata for media players may include information such as support for various file formats, codecs, DRMs, network protocols, and license operations such as importing a license), the media player's location, manufacturer and device type, as well as the media player's current status.

The content management server 105 may also include external metadata 155 for storing metadata acquired from sources outside of the local network 120. This metadata may be acquired from websites or an external database 152. In some embodiments, the external metadata may include user reviews associated with certain media files. For example, the metadata may include user reviews from Amazon.com or another website. The external metadata may also include images or album covers. Such external metadata is associated with media content such that in the event that the user may select a particular song file for playback though the use of information associated with the song file is presented to the user such as, for example, user reviews for the song, the artist's name, and so forth. The content management server 105 may also include a communication device 245 for communicating with entities on the local network 120 or accessible via the Internet 180.

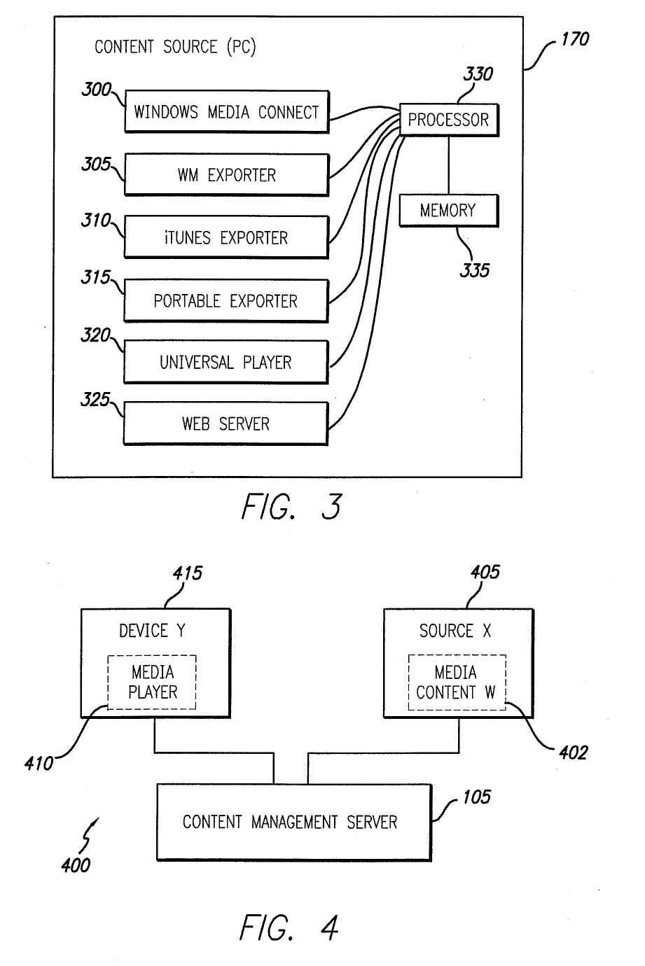

The content management server 105 may be in communication with several other electronic devices via the local network 120. For example, a Universal Plug And Play (“UPNP”) content media player 160 and a UPNP content source 165 may be in communication with the local network 120. The content management server 105 detects the presence of the UPNP content media player 160 and a UPNP content source 165 and searches or scans these devices to determine whether any media content or media players are stored thereon. A content source 170 within a personal computer is also in communication with the local network 120. The content source 170 may include several elements, such as Windows Media Connect™, Windows Media™ Exporter, iTunes™ Exporter, a Portable Exporter, a Universal Player, and a web server, as discussed below with respect to FIG. 3. A portable Audio Device 175 may be in communication with the content source 170. The portable audio device 175 may be in communication with the content source 170 via a Universal Serial Bus (“USB”) connection and a user may store various media from the PC onto the portable audio device 175.

The content management server 105 may further be in communication with the Internet 180. For example, a cellular phone 185 may be in communication with the content management server 105 via the Internet 180.

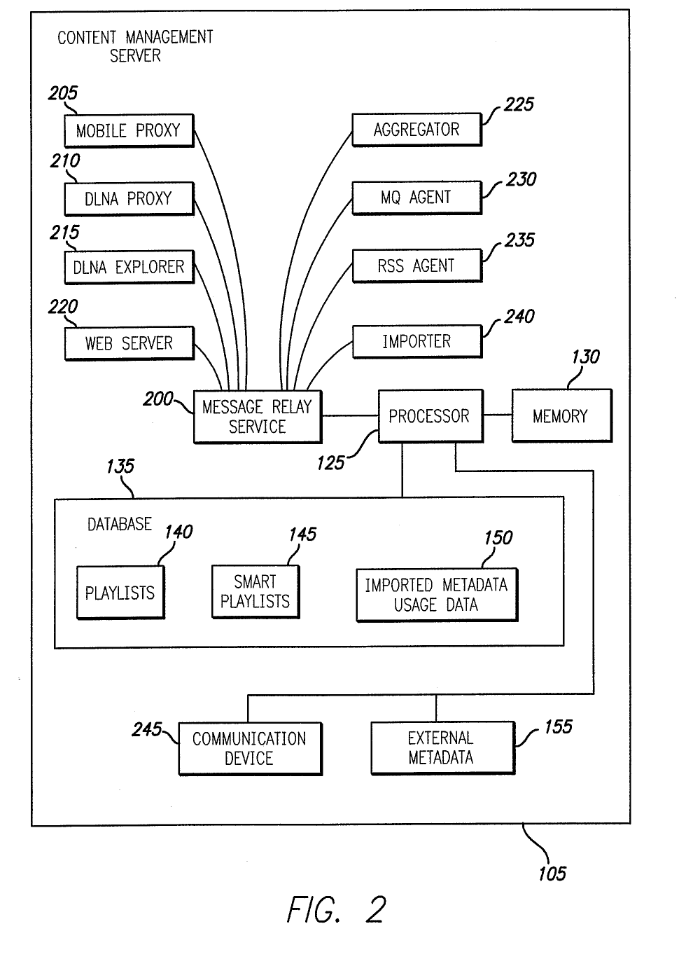

FIG. 2 illustrates the content management server 105 according to an embodiment of the invention. As illustrated, the content management server 105 includes a message relay service module 200. The message relay service module 200 is in communication with several other modules or elements within the content management server 105, such as a mobile proxy 205, a DLNA proxy 210, a DLNA explorer 215, a web server 220, an aggregator 225, an Metadata Quality (“MQ”) agent 230, a Really Simple Syndication (“RSS”) agent 235, an importer 240, and the processor 125. Metadata Quality represents how accurate the metadata collection is. The MQ Agent 230 matches imported metadata against a “ground truth” metadata collection such as, for example, that of AMG or Gracenote.

The content management server 105 is built from a collection of components that communicate via the Message Relay Service. The components of the content management server 105 are highly autonomous and may be independently started and stopped and may run in a shared address space (i.e., a single process) or in a separate address space (i.e., multi-process).

The mobile proxy 205 is responsible for injecting requests from a mobile application executed by the cellular phone 185 into the messaging system. The DNLA proxy 210 is responsible for discovering DNLA-compliant devices on the local network 120 and relaying commands to these devices and relaying events from these devices. The DNLA exporter 215 is responsible for extracting metadata from DNLA-compliant media servers on the local network 120. The content management server 105 includes an embedded web server 220 that is responsible for handling Hypertext Transfer Protocol (“HTTP”) requests from various clients on the local network. The HTTP requests may be for cover images, art work, or content stored on the content management server 105. The aggregator 225 is responsible for maintaining the imported metadata usage data 150 in the embedded database 135. The aggregator 225 also provides an “aggregated view” (i.e., source independent access to content) and information about devices on the local network 120. The MQ agent 230 is responsible for resolving imported metadata against the external metadata 155. The MQ agent 230 obtains the external metadata identifiers for the content. The RSS agent 235 is responsible for polling RSS feeds, storing channel items in the database 135, and caching the cover art images corresponding to media content. The importer 240 is responsible for collecting metadata from exporters on the local network 120 and updating an index in the database 135 of all media content, such as music content, found on the local network 120.

FIG. 3 illustrates a content source (PC) 170 according to an embodiment of the invention. The designation (PC) is utilized herein to indicate that in this case the content source (PC) 170 is a personal computer (“PC”) that is utilized as a content source. However, it should be appreciated that a content source other than a PC may alternatively be utilized. As shown, the content source (PC) 170 may include several elements or entities, such as a Windows™ Media Connect 300, a Windows™ Media Exporter 305, an iTunes™ Exporter 310, a portable exporter 315, a universal player 320, and a web server 325. Each of these elements may be in communication with a processor 330. The processor 330 executes program code or instructions stored in a memory 335.

The Windows™ Media Connect 300 has a function of making content on the PC available to other devices in the home. The Windows™ Media Exporter 305 has a function of extracting metadata from the Windows Media™ library. The iTunes™ Exporter 310 has a function of extracting metadata from the PC version of iTunes™. The portable exporter 315 has a function of discovering any portable devices attached to the content source (PC) 170 and extracting metadata from these devices. The universal player 320 is an embedded media player in the content source (PC) 170. Accordingly, a user of the content source (PC) may directly play media content via the universal player 320. The universal player 320 may encapsulated Windows Media™ Player, a QuickTime™ Player, and a Real G₂™ Player, and supports content playback, both protected and unprotected, on the content management server 105. The web server 325 handles HTTP requests and communicates with the webs server 220 of the content management server 105. The content management server 105 performs various compatibility tests to determine whether a media file is playable by a media player on the local network 120, and, if so, by which media player.

FIG. 4 illustrates a system 400 where a content management server 105 is utilized to determine whether media content W 402 stored on source X 405 is playable on a media player 410 stored on device Y 415 according to an embodiment of the invention. In this example, a user may desire to play the media content W 402 via the media player 410, but may be unsure as to whether it is playable. To determine whether the media content W 402 is playable by the media player 410 of device Y 415, the content management server 105 implements one or more compatibility tests.

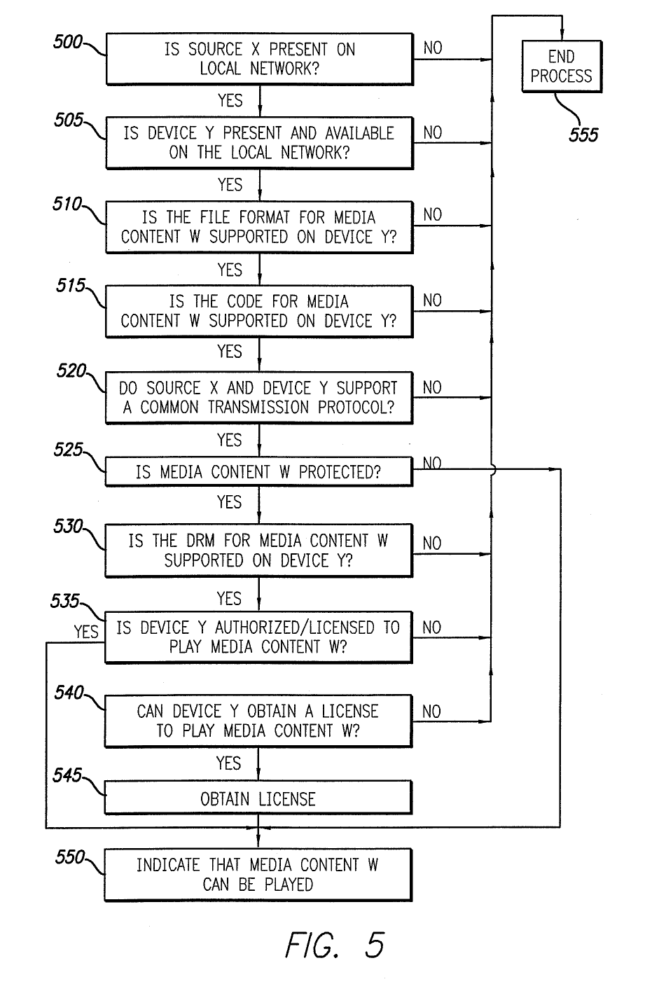

FIG. 5 illustrates a method implementing a compatibility test to determine whether media content W 402 stored on the source X 405 is playable on the media player 410 of device Y 415 according to an embodiment of the invention. First, the content management server 105 determines at operation 500 whether the source X 405 is present on the local network 120. If “yes,” processing proceeds to operation 505. If “no,” on the other hand, processing proceeds to operation 555 where the processing ends. At operation 505, a determination is made regarding whether device Y 415 is present and available on the local network 120. If “yes,” processing proceeds to operation 510. If “no,” on the other hand, processing proceeds to operation 555 where the processing ends. At operation 510, a determination is made regarding whether the file format for media content W 402 is supported on device Y 415. If “yes,” processing proceeds to operation 515. If “no,” processing proceeds to operation 555 where the processing ends.

Next, at operation 515, a determination is made regarding whether the codec for media content W 402 is supported on device Y 415. If “yes,” processing proceeds to operation 520. If “no,” on the other hand, processing proceeds to operation 555 where the processing ends. At operation 520, a determination is made regarding whether source X 405 and device Y 415 support a common transmission protocol. If “yes,” processing proceeds to operation 525. If “no,” on the other hand, processing proceeds to operation 555 where the processing ends. A determination is subsequently made at operation 525 regarding whether media content W 402 is protected. If “yes,” processing proceeds to operation 530. If “no,” on the other hand, processing proceeds to operation 550 where the content management server 105 indicates the media content W 402 can be played on device Y 415. At operation 530, the media content server 105 determines whether the DRM for media content W 402 is supported on device Y 415. If “yes,” processing proceeds to operation 535. If “no,” on the other hand, processing proceeds to operation 555 where the processing ends. Next, at operation 535, a determination is made regarding whether device Y 415 is authorized or licensed to play media content W 402. If “yes,” processing proceeds to operation 550. If “no,” on the other hand, processing proceeds to operation 540 where a determination is made regarding whether device Y 415 can obtain a license to play media content W 402. If “yes,” processing proceeds to operation 545 where the license is obtained and then to operation 550 where the content management server 105 indicates the media content W 402 can be played on device Y 415. If “no” at operation 540, processing proceeds to operation 555 where the process ends.

FIG. 6 illustrates a display screen 600 presented to the user according to an embodiment of the invention. The display screen 600 may be displayed on the TV 115 or on another electronic device in communication with the local network 120. In the event that the user desires to play a selected media content file, the user may select the appropriate media content via an interface of the client 110 and/or the TV 115. In this example, the user has selected the song file “Don't You Want Me” by the Human League. Based on the various metadata accumulated by the content management server 105 for this particular song file and the metadata acquired from various media players on electronic devices on the local network 120, the available devices and/or media players on which this song file can be played are displayed to the user. In this case, the song file is playable on the cellular phone 185 or on the portable audio device 175. The user may select the appropriate device and/or media player on which to play the song file. Additional content associated with the song file is also displayed. As shown, an image 605 of the album cover from which this song was acquired is displayed. User reviews acquired from the external database 152 are also displayed. As shown, two user reviews are available for viewing—user review #1 and user review #2. The user may select the appropriate review to view via use of a mouse/cursor or some other appropriate selection means.

Although FIG. 6 illustrates an example of the type of information displayed to the user when a song file or other media content already stored on a device on the local network, it should be appreciated that these teachings are equally applicable to scenarios where the media content is stored on a remote server or database. For example, in the event that the user desires to purchase a song file, such as “Beat It” by Michael Jackson, the content management server 105 may transmit a query to an external database from which the song file can be purchased. In some embodiments, the song may be purchased from an Internet website or some other accessible medium. To ensure that the song will be playable on one of the media player on the local network 120, the compatibility tests are performed prior to the purchase. Various characteristics about the song file may be transmitted in the form of metadata or in some other usable format to the content management database 105. The content management database subsequently performs the compatibility test discussed above with respect to FIG. 5. Accordingly, after the compatibility tests have been performed, the user will know whether the song file would be playable if downloaded, and if so, on which media players/devices. If a conflict is found, then the user will be presented with the reason(s) for the conflict and a suggestion of things that he or she can do to remedy the situation.

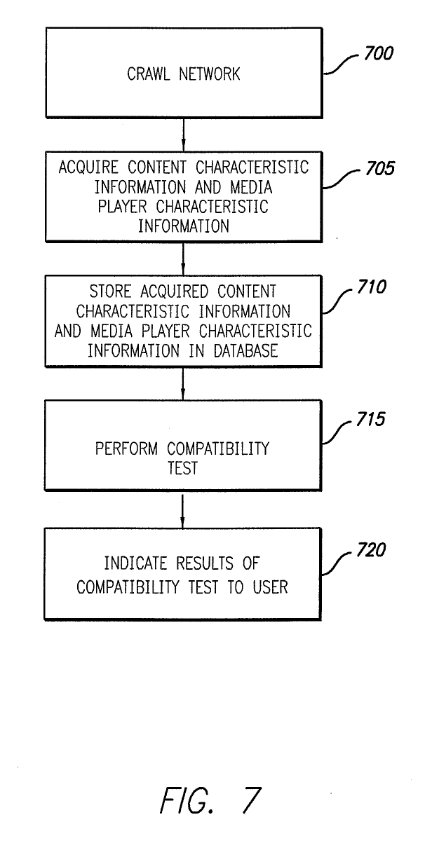

FIG. 7 illustrates a method of implementing the content management system 100 according to an embodiment of the invention. First, at operation 700, the content management server 105 crawls the local network 120 to identify media content and media players within the local network 120. Next, at operation 705, the content management server 105 acquires content characteristic information from the media content and media player characteristic information from the media players. At operation 710, the content characteristic information and the media player characteristic information is stored in the database 135. At operation 715 the content management server 105 performs a compatibility test, based on the content characteristic information and the media player characteristic information, to determine whether selected media content can be played on any of the media players. Finally, at operation 720, a result of the compatibility test is indicated to the user. For example, the results may be displayed on the user interface of the client 110 or on the TV 115 or some other monitor.

The teachings described herein are directed to a content management system. A content management server queries various entities located on a local network and acquires metadata from media players, media content, and/or media services. The metadata is accumulated in a database and is utilized to identify or characterize media content, media players, or media servers with which it is associated. Metadata for media content such as an audio song file may identify, for example, the artist of the song, the DRM for the song, the year during which the song was originally recorded, the year during which the particular song file was created, the style of singing in the song (e.g., Pop or Rock 'n Roll) as well as other relevant information that can be used to identify or characterize the song. Metadata for a media player may include, for example, information regarding the supported media content types that can be played by the media player, and any other relevant information. Metadata for a media service, such as iTunes may include, for example, information regarding DRM and any other relevant information.

The metadata stored within the database may be utilized when performing compatibility tests. For example, a compatibility test may be performed to determine whether a media content file stored on a particular source device can be played with a media player on a particular electronic device. For example, it would be helpful for a user to know whether a media content file currently stored on a home computer will be playable on a portable media device such as an iPod™ or MP3 media player.

The compatibility test may also be performed to indicate whether a particular media content file can be played on any device on the local network. This may be relevant in a situation where a user desires to purchase the media content file. It may be useful if the user can determine whether a media content file is playable before paying for it and downloading it.

The content management server also presents the accumulated metadata to the user when related media content is selected for play. In the event that a particular song file has been detected on the local network, the content management server may query an external database to acquire additional relevant metadata for the song file, such as an image of an associated album cover or user reviews of the song and/or the album from which the song was originally released. This metadata may be presented to the user in a number of ways. For example, when the song file is played, the image of the album cover may be displayed on a monitor or television screen, along with one or more of the user reviews.

Embodiments of the present invention are directed to a content management system for a local network, such as a home network. Several electronic storage devices for storing digital media are connected to the local network. Several other electronic devices may also be in communication with the local network. Each of the electronic devices may include a media player for playing the digital media for a user's enjoyment. It should be appreciated that some, or all, of the electronic devices may include one or more media players and a memory for storing one or more items of the digital media.

This invention has been described in detail with reference to various embodiments. Not all features are required of all embodiments. It should also be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art. Numerous modifications and variations could be made thereto by those skilled in the art without departing from the scope of the invention set forth in the claims.

What is claimed is:

1. A method, comprising:
crawling a network to identify media content and media players within the network;
acquiring content characteristic information from the media content and media player characteristic information from the media players;
storing the content characteristic information and the media player characteristic information in a database;
performing a compatibility test, based on the content characteristic information and the media player characteristic information, to determine whether selected media content can be played on any of the media players; and
indicating a result of the compatibility test to a user.

2. The method of claim 1, wherein the content characteristic information comprises content metadata, and the media player characteristic information comprises media player metadata.

3. The method of claim 1, further comprising importing second content characteristic information corresponding to the media content from a source external to the network, and utilizing the second content characteristic information during the performing of the compatibility test.

4. The method of claim 1, further comprising playing a selected media content on a compatible media player in response to performance of the compatibility test determining the compatible media player from among the media players.

5. The method of claim 4, further comprising presenting at least some media associated with the content characteristic information to a user during the playing.

6. The method of claim 5, wherein the content characteristic information comprises at least one of content metadata, a content identifier, content licensing information, digital rights management information, and replication data.

7. The method of claim 1, wherein the performing of the compatibility test comprises determining:
whether a particular media device and a particular source on which the media content is stored are available on the network;
whether a file format of the selected media content is supported on the particular media device;
whether a specified codec for the selected media content is supported on the particular media device;
whether the particular source and the particular media support a common transmission protocol; and
whether the particular media content is protected

8. The method of claim 7, wherein the determining whether the particular media content is protected comprises
determining whether digital rights management for the particular media content is supported on the particular media device, and
determining whether the particular media device is authorized to play the particular media content.

9. The method of claim 1, wherein the indicating the result of the compatibility test to the user comprises indicating at least one of:
a success; and
a reason for failure and possible actions available to the user to remedy the failure.

10. A content management server, comprising:
at least one relay element to identify media content and media players within a network and acquire content characteristic information from the media content and media player characteristic information from the media players;
a database to store the content characteristic information and the media player characteristic information; and
a processor to perform a compatibility test, based on the content characteristic information and the media player characteristic information, to determine whether selected media content is playable on any of the media players and to indicate a result of the compatibility test via a user interface.

11. The content management server of claim 10, wherein the content characteristic information comprises content metadata, and the media player characteristic information comprises media player metadata.

12. The content management server of claim 10, further comprising a communication device to import second content characteristic information corresponding to the media content from a source external to the network.

13. The content management server of claim 10, wherein the content characteristic information comprises at least one of content metadata, a content identifier, content licensing information, digital rights management information, and replication data.

14. The content management server of claim 10, wherein the processor is adapted to perform the compatibility test comprising:
determining whether a particular media device and a particular source on which the media content is stored are available on the network;
determining whether a file format of the selected media content is supported on the particular media device;
determining whether a specified codec for the selected media content is supported on the particular media device;
determining whether the particular source and the particular media support a common transmission protocol; and
determining whether the particular media content is protected.

15. The content management server of claim 10, wherein the result of the compatibility test to the user comprises indicates at least one of:
a success; and
a reason for failure and possible actions available to the user to remedy the failure.

16. A network, comprising:
at least one electronic device to implement at least one media player;
at least one content source to store media content; and
a content management server to
crawl the network to identify the media content and the at least one media player within the network;
acquire content characteristic information from the media content and media player characteristic information from the at least one media player;
store the content characteristic information and the media player characteristic information in a database;
perform a compatibility test, based on the content characteristic information and the media player characteristic information, to determine whether selected media content can be played on any of the at least one media player; and
indicate a result of the compatibility test to a user.

17. The network of claim 16, wherein the content characteristic information comprises content metadata, and the media player characteristic information comprises media player metadata.

18. The network of claim 16, further comprising an importer to import second content characteristic information corresponding to the media content from a source external to the network, and utilize the second content characteristic information during the performing of the compatibility test.

19. The network of claim 16, further comprising a display to present at least some data associated with the content characteristic information to a user during the playing.
